(19) United States
(12) Patent Application Publication
(10) Pub. No.: US 2026/0296830 A1
(43) Pub. Date: Oct. 1, 2026

(54) PRINTING DEVICE

(71) Applicant: SEIKO EPSON CORPORATION, Tokyo (JP)

(72) Inventors: Kazuhisa KATO, MATSUMOTO-SHI (JP); Kenichi TANIOKA, MATSUMOTO-SHI (JP)

(21) Appl. No.: 19/577,752

(22) Filed: Mar. 25, 2026

(30) Foreign Application Priority Data
Mar. 26, 2025 (JP) 2025-051238

(51) Int. Cl. B65H 79/00; B41J 15/04; B65H 16/06; B65H 16/10; B65H 18/16; B65H 26/06

(52) U.S. Cl. CPC B65H 79/00; B41J 15/048; B65H 16/06; B65H 16/10; B65H 18/16; B65H 26/06; B65H 2403/481

(57) ABSTRACT

When a user performs an operation of removing a roll body RP from a medium holding unit 42 in a state in which a leading end PA of a medium is located downstream of a first roller pair 51 in a forward direction, a printing device 1 executes a first reverse conveyance operation of rotating a first driving roller 51a in a second direction such that the medium moves in a reverse direction by a first distance, executes a first forward conveyance operation of rotating the first driving roller 51a in a first direction such that a planetary gear 132 moves from a first position to a second position, and executes a second reverse conveyance operation of rotating the first driving roller 51a in the second direction such that the medium moves in the reverse direction by a second distance.

The present application is based on, and claims priority from JP Application Serial Number 2025-051238, filed Mar. 26, 2025, the disclosure of which is hereby incorporated by reference herein in its entirety.

### BACKGROUND

### 1. Technical Field

The present disclosure relates to a printing device.

### 2. Related Art

According to the related art, various printing devices are used. Among them, there is a printing device capable of using a roll body obtained by winding a long medium in a roll shape, such as a printing device in JP-A-2014-73595.

JP-A-2014-73595 is an example of the related art.

JP-A-2014-73595 states that, in the printing device, a driving force of a driving source is transmitted, when feeding the medium in a forward direction, to a conveyance roller pair such that the medium is in a forward rotation direction, and the driving force of the driving source is switched using a planetary gear so as to drive both the conveyance roller pair and a support shaft of the roll body in a reverse rotation direction when rewinding the medium in a reverse direction. However, in the printing device having such a configuration, when the user removes the roll body, the medium is rewound by a certain length regardless of a remaining amount of the medium constituting the roll body. Therefore, a position of a leading end of the medium after rewinding may vary due to variations in the type of the medium, the remaining amount of the medium, the weight of the roll body, the degree of curling of the medium, and the like, and the leading end of the medium may remain nipped by the conveyance roller pair even after the medium is rewound. The reason for rewinding the medium by a certain length without excessively increasing the rewinding amount of the medium lies in that, when the rewinding amount of the medium is excessively increased, a state in which a strong nip force is applied to the medium from a roller pair or the like in the conveyance path becomes long, and there is a concern that the medium is strongly curled or damaged, and control becomes easy by setting the certain length.

In addition, after the medium is rewound, when the user sets the next roll body on the support shaft and passes the leading end of the medium through the conveyance path, it is important that the support shaft can freely rotate in order to improve the operability of the user. However, in order to freely rotate the support shaft, a temporary operation in the forward rotation direction by a releasing operation of the planetary gear is required. With this operation, even if the leading end of the rewound medium is located upstream of the conveyance roller pair in the forward direction, the conveyance roller pair may wind the leading end of the medium due to the conveyance of the roll paper in the forward direction accompanying the releasing operation of the planetary gear, and the user may not remove the roll body nipped by the conveyance roller pair.

### SUMMARY

According to the present disclosure for solving the above problems, there is provided a printing device including: a medium holding unit including a first shaft that rotatably holds a roll body obtained by winding a long medium in a roll shape; a conveyance path through which the medium is to be conveyed; a printing unit facing the conveyed medium; a first roller pair including a first driving roller and a first driven roller, and rotating to convey the medium in a forward direction and a reverse direction opposite to the forward direction; a first shaft gear provided on the first shaft and configured to rotate the first shaft; a first roller gear provided on a second shaft that rotatably supports the first driving roller, and configured to rotate the first driving roller; a drive unit configured to generate a driving force for rotating the first driving roller in a first direction and a second direction opposite to the first direction; a power transmission mechanism configured to transmit, when the drive unit rotates the first driving roller in the second direction, the driving force of the drive unit to the first shaft as a rotational force in a direction in which the medium is rewound to the medium holding unit side; and a control unit configured to control the drive unit, in which the power transmission mechanism includes a sun gear rotated by the driving force of the drive unit and transmitting the driving force of the drive unit to the first roller gear, a planetary gear rotatable about a rotation center of the sun gear in a state in which the planetary gear meshes with the sun gear, and a pivoting member pivotable about the rotation center of the sun gear in a state in which the planetary gear is held, when the drive unit rotates the first driving roller in the second direction, the pivoting member pivots such that the planetary gear is located at a first position at which the driving force of the drive unit is transmitted to the first shaft gear, and when the drive unit rotates the first driving roller in the first direction, the pivoting member pivots such that the planetary gear is located at a second position at which the driving force of the drive unit is not transmitted to the first shaft gear, and when a user performs an operation of removing the roll body from the medium holding unit in a state in which a leading end of the medium is located downstream of the first roller pair in the forward direction, the control unit controls the drive unit to execute a first reverse conveyance operation of rotating the first driving roller in the second direction such that the medium moves in the reverse direction by a first distance, execute a first forward conveyance operation of rotating the first driving roller in the first direction such that the planetary gear moves from the first position to the second position, and execute a second reverse conveyance operation of rotating the first driving roller in the second direction such that the medium moves in the reverse direction by a second distance.

### BRIEF DESCRIPTION OF THE DRAWINGS

FIG. 1 is a side cross-sectional view illustrating an internal configuration of a printing device according to an embodiment of the present disclosure.

FIG. 2 is a side view illustrating a peripheral structure of a power transmission mechanism of the printing device in FIG. 1 and illustrating a state in which a pivoting member is located at a first position.

FIG. 3 is a perspective view illustrating the peripheral structure of the power transmission mechanism of the printing device in FIG. 1, and illustrating a state in which the pivoting member is located at the first position.

FIG. 4 is a side view illustrating a part of the power transmission mechanism of the printing device in FIG. 1 and illustrating a state in which the pivoting member is located at the first position.

FIG. 5 is a side view illustrating a part of the power transmission mechanism of the printing device in FIG. 1 and illustrating a state in which the pivoting member is located at a second position.

FIG. 6 is a side cross-sectional view illustrating a peripheral structure of a first roller pair and a second roller pair of the printing device in FIG. 1.

FIG. 7 is a flowchart when a roll body is removed from the printing device in FIG. 1.

### DESCRIPTION OF EMBODIMENTS

First, the present disclosure is schematically described.

According to a first aspect of the present disclosure for solving the above problems, there is provided a printing device including: a medium holding unit including a first shaft that rotatbaly holds a roll body obtained by winding a long medium in a roll shape; a conveyance path through which the medium is to be conveyed; a printing unit facing the conveyed medium; a first roller pair including a first driving roller and a first driven roller, and rotating to convey the medium in a forward direction and a reverse direction opposite to the forward direction; a first shaft gear provided on the first shaft and configured to rotate the first shaft; a first roller gear provided on a second shaft that rotatably supports the first driving roller, and configured to rotate the first driving roller; a drive unit configured to generate a driving force for rotating the first driving roller in a first direction and a second direction opposite to the first direction; a power transmission mechanism configured to transmit, when the drive unit rotates the first driving roller in the second direction, the driving force of the drive unit to the first shaft as a rotational force in a direction in which the medium is rewound to the medium holding unit side; and a control unit configured to control the drive unit, in which the power transmission mechanism includes a sun gear rotated by the driving force of the drive unit and transmitting the driving force of the drive unit to the first roller gear, a planetary gear rotatable about a rotation center of the sun gear in a state in which the planetary gear meshes with the sun gear, and a pivoting member pivotable about the rotation center of the sun gear in a state in which the planetary gear is held, when the drive unit rotates the first driving roller in the second direction, the pivoting member pivots such that the planetary gear is located at a first position at which the driving force of the drive unit is transmitted to the first shaft gear, and when the drive unit rotates the first driving roller in the first direction, the pivoting member pivots such that the planetary gear is located at a second position at which the driving force of the drive unit is not transmitted to the first shaft gear, and when a user performs an operation of removing the roll body from the medium holding unit in a state in which a leading end of the medium is located downstream of the first roller pair in the forward direction, the control unit controls the drive unit to execute a first reverse conveyance operation of rotating the first driving roller in the second direction such that the medium moves in the reverse direction by a first distance, execute a first forward conveyance operation of rotating the first driving roller in the first direction such that the planetary gear moves from the first position to the second position, and execute a second reverse conveyance operation of rotating the first driving roller in the second direction such that the medium moves in the reverse direction by a second distance.

According to this aspect, when the user performs the operation of removing the roll body from the medium holding unit in a state in which the leading end of the medium is located downstream of the first roller pair in the forward direction, the first reverse conveyance operation of rotating the first driving roller in the second direction such that the medium moves in the reverse direction by the first distance is executed. Thereafter, the first forward conveyance operation of rotating the first driving roller in the first direction such that the planetary gear moves from the first position to the second position is executed. Thereafter, the second reverse conveyance operation of rotating the first driving roller in the second direction such that the medium moves in the reverse direction by the second distance is executed. By executing such an operation, it is possible to prevent a situation in which the conveyance roller pair such as the first roller pair winds the leading end of the medium, and the user cannot remove the roll body. Therefore, the roll body of the medium can be easily taken out.

The printing device according to a second aspect of the present disclosure, which is an aspect dependent on the above first aspect, further includes a detection unit provided upstream of the first roller pair in the conveyance path in the forward direction and configured to detect whether the medium is located at a predetermined position in the conveyance path. The control unit executes the second reverse conveyance operation when the detection unit detects that the medium is located at the predetermined position after the first reverse conveyance operation is completed.

According to this aspect, the detection unit capable of detecting whether the medium is located at the predetermined position in the conveyance path is provided upstream of the first roller pair in the conveyance path in the forward direction, and after the first reverse conveyance operation is completed, the second reverse conveyance operation is executed when the detection unit detects that the medium is located at the predetermined position. By executing such an operation, the second reverse conveyance operation can be performed only when the detection unit detects the medium. That is, the second reverse conveyance operation can be performed only when necessary, and thus, it is possible to shorten the time required for taking out the roll body of the medium and to save power.

The printing device according to a third aspect of the present disclosure, which is an aspect dependent on the above first aspect, further includes a second roller pair including a second driving roller and a second driven roller, and configured to rotate so as to convey the medium in the forward direction and the reverse direction. The second roller pair is located upstream of the first roller pair in the forward direction, and is configured to nip, when a curl occurs in the medium, a curl portion, which is a portion where the curl occurs, to bend the medium in a direction of correcting the curl portion.

According to this aspect, provided is the second roller pair which is located upstream of the first roller pair in the forward direction and nips, when the curl occurs in the medium, the curl portion, which is a portion where the curl occurs, to bend the medium in the direction of correcting the curl portion. With such a configuration, when the medium is curled, correction for reducing the curl can be performed.

In the printing device according to a fourth aspect of the present disclosure, which is an aspect dependent on the above third aspect, the control unit releases, after the second reverse conveyance operation is completed, a contact state in which the rollers of the second roller pair come into contact with each other.

According to this aspect, the contact state in which the rollers of the second roller pair come into contact with each other is released after the second reverse conveyance operation is completed. By executing such an operation, when the leading end of the medium is inserted into the conveyance path as the next roll body is attached, the leading end of the medium is not caught by the second roller pair which is a roller pair upstream of the first roller pair in the forward direction, and the operability when attaching the roll body can be improved.

In the printing device according to a fifth aspect of the present disclosure, which is an aspect dependent on the above second aspect, the detection unit executes, after the first forward conveyance operation is completed, an operation of detecting whether the medium is located at the predetermined position.

According to this aspect, the detection unit executes, after the first forward conveyance operation is completed, the operation of detecting whether the medium is located at the predetermined position. When such an operation is executed, the second reverse conveyance operation can be performed only when necessary, and thus, it is possible to shorten the time required for taking out the roll body of the medium and to save power.

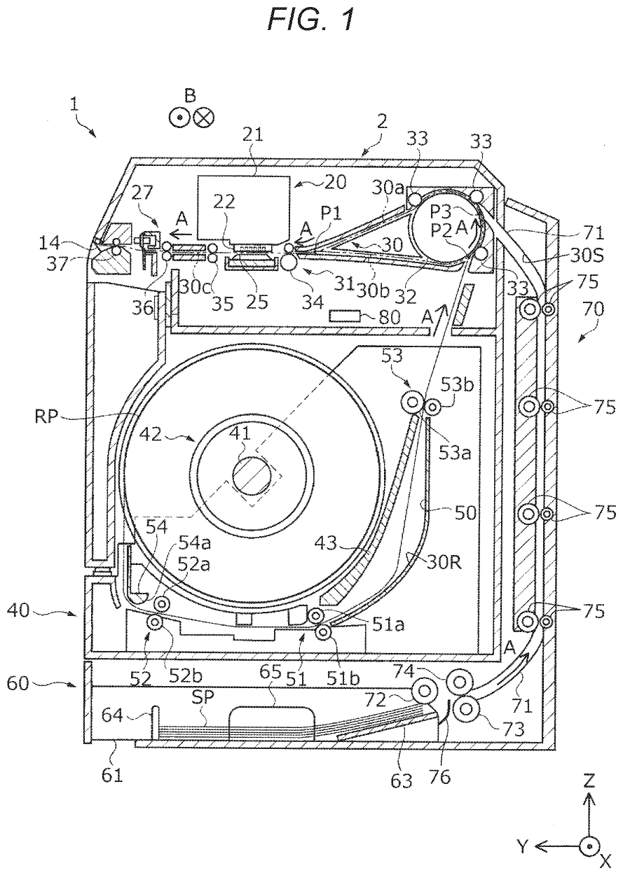

Hereinafter, an embodiment according to the present disclosure will be specifically described with reference to the drawings. First, an outline of a printing device 1 according to an embodiment of the present disclosure will be described with reference to FIG. 1. The printing device 1 is, for example, an inkjet printer that performs printing by discharging ink onto a medium. In coordinates illustrated in the drawings, it is assumed that the printing device 1 is placed on a horizontal plane, and three virtual axes orthogonal to one another are represented as an X axis, a Y axis, and a Z axis. The Y axis is an axis parallel to a front-rear direction of the printing device 1, and a tip side of an arrow indicating the Y axis is represented as “front”. The X axis is an axis parallel to a left-right direction of the printing device 1, and a tip side of an arrow indicating the X axis is represented as “right”. The Z axis is a virtual axis parallel to the vertical direction, and a tip side of an arrow indicating the Z axis is represented as “upper”.

As illustrated in FIG. 1, the printing device 1 includes a housing 2. The inside of the housing 2 is provided with a roll paper accommodation unit 40 that accommodates roll paper RP as a medium, a single sheet paper accommodation unit 60 that accommodates single sheet paper SP as a medium other than the roll paper RP, and a printing unit 20 that can perform printing on the roll paper RP supplied from the roll paper accommodation unit 40 and can perform printing on the single sheet paper SP supplied from the single sheet paper accommodation unit 60.

The printing unit 20 includes a head 22 including nozzles that eject ink toward the medium, and a carriage 21 on which the head 22 is mounted. In addition, the printing unit 20 is configured to reciprocate the carriage 21 along the X axis. A support portion 25 that supports the medium is provided at a position facing the head 22. The head 22 performs printing on the medium supported by the support portion 25 by discharging ink while reciprocating in a width direction B together with the carriage 21. In the embodiment, a serial head type in which the head 22 reciprocates in the width direction is exemplified as the printing unit 20. Alternatively, the printing unit 20 may be a line head type printing unit in which the head extends in the width direction and is fixedly arrayed.

A conveyance path 30 through which the medium is conveyed and a cutting unit 27 capable of cutting the medium on which printing is performed by the printing unit 20 are provided inside the housing 2. The conveyance path 30 includes a supply path 30a and a reverse path 30b provided upstream of the support portion 25, and a discharge path 30c provided downstream of the support portion 25. Furthermore, the supply path 30a includes a roll paper supply path 30R to which roll paper RP, which is an example of a medium, is supplied, and a single sheet paper supply path 30S to which single sheet paper SP, which is an example of a medium, is supplied.

The supply path 30a is a path connecting the roll paper supply path 30R to the support portion 25. A roll paper merging point P2 of merging with the roll paper supply path 30R is provided upstream of the supply path 30a. A branch point P1 of branching from the supply path 30a when the medium is conveyed from downstream to upstream is provided downstream of the supply path 30a. The reverse path 30b is a path connecting the branch point P1 to the roll paper merging point P2. A single sheet paper merging point P3 of merging with the single sheet paper supply path 30S is provided between the roll paper merging point P2 and the branch point P1 in the supply path 30a.

A discharge port 14 through which a medium on which the printing is performed is discharged is provided on a front surface of the housing 2. The discharge path 30c is a path connecting the support portion 25 to the discharge port 14. A cutting unit 27 that cuts the medium printed by the printing unit 20 is provided halfway in the discharge path 30c.

The conveyance path 30 is provided with a conveyance unit 31 that conveys the medium supplied to the conveyance path 30. The conveyance unit 31 includes an intermediate roller 32, a plurality of driven rollers 33 provided on an outer periphery of the intermediate roller 32, and an upstream conveyance roller pair 34 in order from upstream to downstream in the supply path 30a. The driven roller 33 is rotatably provided and is driven to rotate with the medium sandwiched between the driven roller 33 and the intermediate roller 32. The conveyance unit 31 includes a downstream conveyance roller pair 35, a roller pair 36, and a roller pair 37 in the discharge path 30c in order from upstream to downstream. The roller pair 36 is located upstream of the cutting unit 27, and the roller pair 37 is located downstream of the cutting unit 27.

The intermediate roller 32, the driven rollers 33, the upstream conveyance roller pair 34, the downstream conveyance roller pair 35, the roller pair 36, and the roller pair 37 convey the medium by rotating in a state of sandwiching the medium. When the conveyance unit 31 is driven to rotate forward, the medium is conveyed from upstream to downstream in a conveyance direction A, that is, the forward direction. When the conveyance unit 31 is reversely driven, the medium is conveyed in a direction opposite to the conveyance direction A, that is, from downstream to upstream, which is the reverse direction.

The printing device 1 performs printing on a first surface of the medium by ejecting ink from the printing unit 20 onto the medium located on the support portion 25 while conveying the medium from upstream to downstream by driving the conveyance unit 31 to rotate forward. The printing device 1 is configured to perform printing on a second surface that is a back surface of the first surface of the medium. The printing device 1 drives the conveyance unit 31 to reversely rotate to convey, in the reverse direction, the medium after the printing is performed on the first surface. The medium reaches upstream of the supply path 30a from the branch point P1 through the reverse path 30b. The printing device 1 drives the conveyance unit 31 to rotate forward again, and the medium makes full one turn around an outer circumference of the intermediate roller 32, so that the front and back of the medium are reversed. The printing device 1 ejects ink from the printing unit 20 onto the medium located on the support portion 25 while conveying the medium from upstream to downstream, and performs printing on the second surface of the medium. Accordingly, printing is executed on both the surfaces of the medium. In the case of the roll paper RP obtained by unwinding the medium from a roll state, the printing on the back surface is executed on the medium cut into a single sheet paper state by the cutting unit 27 after the printing on the front surface.

The roll paper accommodation unit 40 is also provided inside the housing 2. The roll paper accommodation unit 40 includes a first medium holding unit 42 that holds the roll paper RP in a roll body state, and the roll paper RP is rotatably supported via a support shaft 41 which is a first shaft extending in the X direction of the housing 2. That is, the roll paper RP is rotatably supported by the roll paper accommodation unit 40 together with the support shaft 41 with the support shaft 41 as a rotation center. The support shaft 41 is configured to be rotatable in both a forward rotation direction and a reverse rotation direction. In the roll paper accommodation unit 40, a roll paper conveyance path 50 through which the roll paper RP unwound from the roll state is conveyed is provided at a position facing a support member 43. The roll paper conveyance path 50 constitutes the roll paper supply path 30R.

The roll paper conveyance path 50 includes a first roller pair 51, a second roller pair 52, a third roller pair 53, and a curved surface portion 54. The first roller pair 51 includes a driving roller 51a that is driven by a motor, and a driven roller 51b that faces the driving roller 51a and is driven to rotate as the driving roller 51a rotates. The second roller pair 52 includes a driving roller 52a driven by a motor, and a driven roller 52b that faces the driving roller 52a and is driven to rotate as the driving roller 52a rotates. The third roller pair 53 includes a driving roller 53a that is driven by a motor, and a driven roller 53b that faces the driving roller 53a and is driven to rotate as the driving roller 53a rotates. The curved surface portion 54 has a curved surface 54a on which the conveyed medium slides. In the roll paper conveyance path 50, the first roller pair 51, the second roller pair 52, and the third roller pair 53 are driven to rotate forward while being pressed against the curved surface 54a of the curved surface portion 54, and thus the medium is conveyed from upstream to downstream in the conveyance direction A, that is, the forward direction.

The single sheet paper accommodation unit 60 is provided inside the housing 2. The single sheet paper accommodation unit 60 includes a box-shaped tray 61 in which single sheet paper SP, which is a single sheet medium, is accommodated. The tray 61 includes a pair of edge guides 65 operated when positioning the single sheet paper SP in the width direction, a stopper 64 operated when positioning the single sheet paper SP in the front-rear direction, and a placement surface 63 on which a downstream end portion of the single sheet paper SP accommodated in the tray 61 faces a pickup roller 72.

The single sheet paper accommodation unit 60 forms a part of a single sheet paper supply unit 70 that supplies the single sheet paper SP toward the printing unit 20. The single sheet paper supply unit 70 includes the single sheet paper accommodation unit 60 having the placement surface 63 as a placement unit on which a plurality of pieces of single sheet paper SP can be placed, a single sheet paper conveyance path 71, the pickup roller 72, a retard roller 73, a separation roller 74 serving as feeding rollers that are provided at positions facing the single sheet paper accommodation unit 60 and feed the single sheet paper SP placed on the single sheet paper accommodation unit 60 in the conveyance direction A (forward direction) from the single sheet paper accommodation unit 60 toward the printing unit 20, a separation member 76, and the like.

The single sheet paper conveyance path 71 is bent upward from the separation roller 74 and the retard roller 73 and constitutes the single sheet paper supply path 30S. In the single sheet paper conveyance path 71, single sheet paper conveyance roller pairs 75 that apply a conveyance force to the single sheet paper SP are provided at an appropriate interval. The single sheet paper SP is conveyed by rotationally driving the single sheet paper conveyance roller pair 75.

As described above, the printing device 1 according to the embodiment includes the conveyance unit 31 that conveys the medium in the conveyance direction A (forward direction) along the conveyance path 30, and the printing unit 20 that performs printing by ejecting droplets onto the medium conveyed in the conveyance path 30. The roll paper supply path 30R includes the curved surface portion 54 having the curved surface 54a, the first roller pair 51, the second roller pair 52, and the third roller pair 53.

Here, the second roller pair 52 conveys the medium in the conveyance path 30 while pressing the medium against the curved surface 54a of the curved surface portion 54. When the conveyance is continuously stopped in a state in which the medium is pressed against the curved surface 54a of the curved surface portion 54, a curl (bending tendency) protruding downward along the curved surface 54a may occur. Therefore, the second roller pair 52 is configured to convey the medium in a state of being curled so as to protrude upward in a direction opposite to the curved surface 54a.

In other words, the printing device 1 according to the embodiment includes the curved surface portion 54 provided in the conveyance path 30 and serving as a winding portion around which the medium can be wound, and the second roller pair 52 serving as a de-curl roller pair that is located downstream of the curved surface portion 54 in the conveyance direction A (forward direction) and can perform a de-curl operation of nipping and bending, in a correcting direction, a curl portion generated in the medium by being wound around the curved surface portion 54. Furthermore, as illustrated in FIG. 1, the printing device 1 according to the embodiment includes a control unit 80. The control unit 80 can control the second roller pair 52 to execute the de-curl operation and can control the conveyance of the medium by the conveyance unit 31. In the printing device 1 according to the embodiment, the first roller pair 51 is a main conveyance roller pair for conveying a medium, and the second roller pair 52 is a conveyance roller pair mainly for the purpose of executing a de-curl operation.

As described above, the printing device 1 according to the embodiment includes the second roller pair 52 that includes the driving roller 52a serving as the second driving roller and the driven roller 52b serving as the second driven roller and rotates so as to convey the medium in the forward direction and the reverse direction. The second roller pair 52 is located upstream of the first roller pair 51 in the conveyance direction A (forward direction), and is configured to nip, when a curl occurs in the medium, a curl portion, which is a portion where the curl occurs, to bend the medium in a direction of correcting the curl portion. With such a configuration, the printing device 1 according to the embodiment can perform correction to reduce the curl when the curl is generated in the medium.

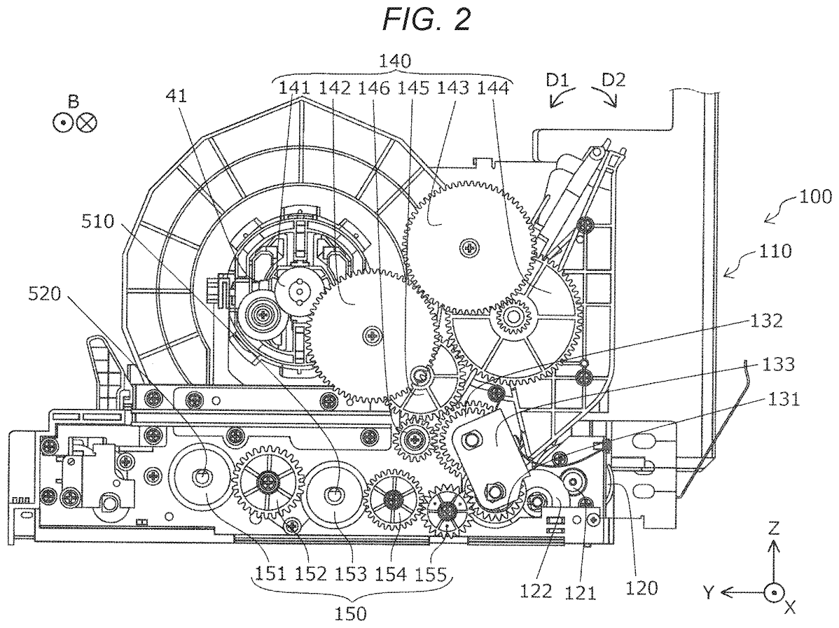

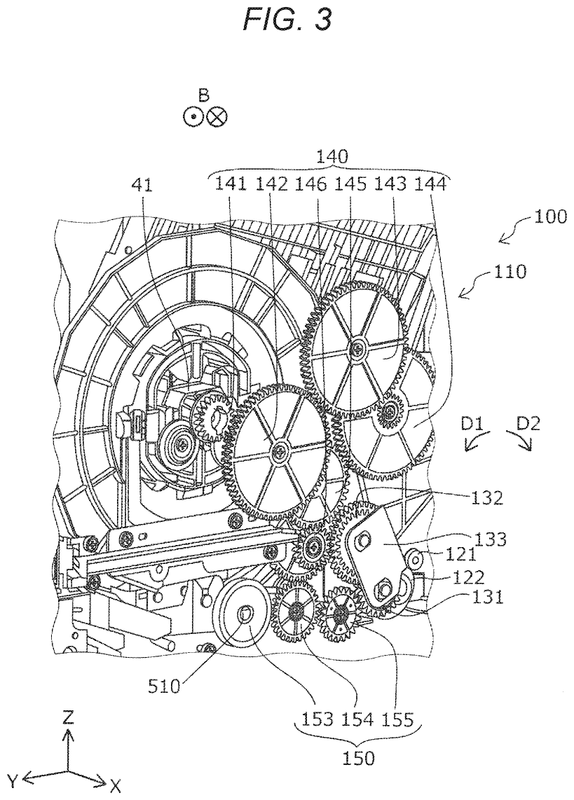

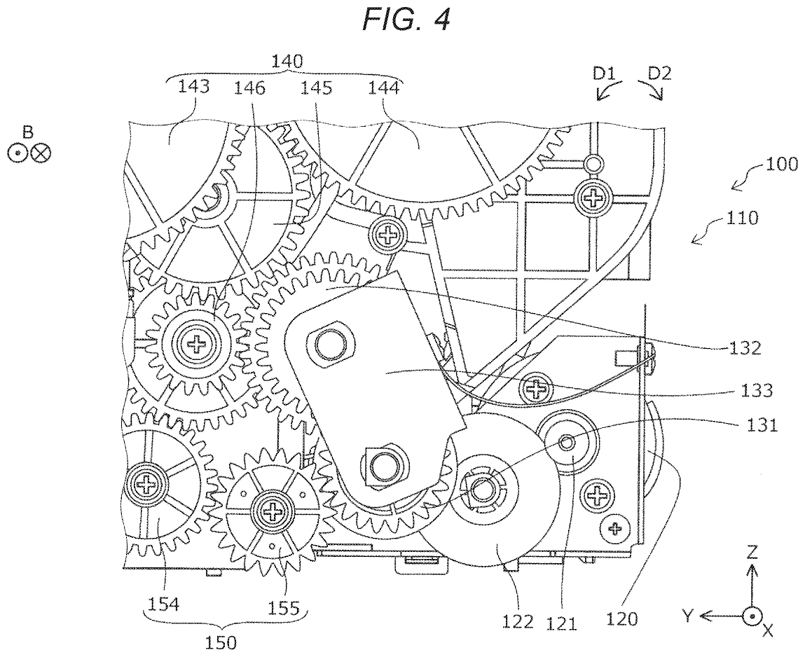

Hereinafter, the printing device 1 according to the embodiment will be described in more detail with reference to FIGS. 2 to 6 in addition to FIG. 1. As described above, the printing device 1 according to the embodiment includes the first medium holding unit 42 including the support shaft 41 serving as the first shaft that rotatably holds the roll paper RP which is a roll body obtained by winding a long medium in a roll shape, the conveyance path 30 through which the medium is conveyed, and the printing unit 20 provided at a position facing the medium conveyed through the conveyance path 30. Furthermore, there is provided the first roller pair 51 that includes the driving roller 51a serving as a first driving roller and the driven roller 51b serving as a first driven roller and is configured to rotate so as to convey the medium in a forward direction and a reverse direction opposite to the forward direction.

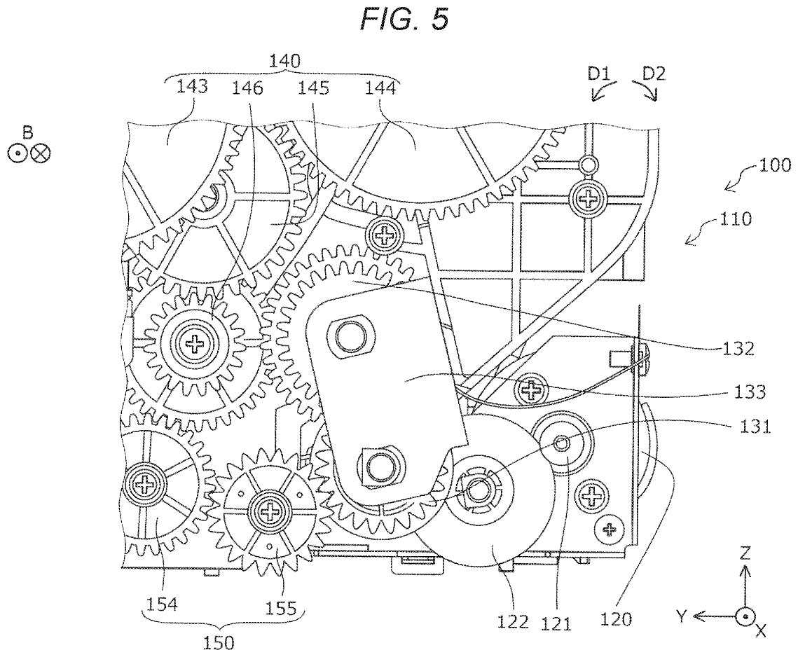

As illustrated in FIGS. 2 to 5, the printing device 1 according to the embodiment includes a power transmission unit 100 including a drive unit 120 that is a motor, and a power transmission mechanism 110 including a train wheel transmitting a driving force of the drive unit 120. Here, the power transmission unit 100 will be described. The power transmission unit 100 includes a gear 121 provided on a rotation shaft of the drive unit 120, and a gear 122 meshing with the gear 121. The gear 122 meshes with a sun gear 131, the sun gear 131 meshes with a planetary gear 132, and the sun gear 131 and the planetary gear 132 are coupled by a pivoting member 133. The pivoting member 133 is configured to be rotatable in a pivoting direction D1 and a pivoting direction D2 with reference to the sun gear 131. FIGS. 2 to 4 illustrate a state in which the pivoting member 133 rotates to the maximum extent in the pivoting direction D1. FIG. 5 illustrates a state in which the pivoting member 133 rotates to the maximum extent in the pivoting direction D2.

The power transmission mechanism 110 includes a first power transmission mechanism 140 capable of transmitting power of the drive unit 120 to the support shaft 41 as the first shaft, and a second power transmission mechanism 150 capable of transmitting the power of the drive unit 120 to the driving roller 51a of the first roller pair 51 and the driving roller 52a of the second roller pair 52. The first power transmission mechanism 140 includes a first shaft gear 141 attached to the support shaft 41 serving as the first shaft, a gear 142 meshing with the first shaft gear 141, a gear 143 meshing with the gear 142, a gear 144 meshing with the gear 143, a gear 145 meshing with the gear 144, and a gear 146 meshing with the gear 145. As illustrated in FIGS. 2 to 4, in a state in which the pivoting member 133 is located at a first position at which the pivoting member 133 has pivoted to the maximum extent in the pivoting direction D1, the planetary gear 132 meshes with the gear 146. On the other hand, for example, as illustrated in FIG. 5, when the pivoting member 133 pivots in the pivoting direction D2 from the state illustrated in FIGS. 2 to 4, the planetary gear 132 is disengaged from the gear 146.

The second power transmission mechanism 150 includes a gear 151 provided on a shaft 520 of the driving roller 52a of the second roller pair 52, a gear 152 meshing with the gear 151, a first roller gear 153 that meshes with the gear 152 and is provided on a second shaft 510 that is a shaft of the driving roller 51a of the first roller pair 51, a gear 154 meshing with the first roller gear 153, and a gear 155 meshing with the gear 154. The gear 155 meshes with the sun gear 131 both in a state in which the pivoting member 133 is located at the first position at which the pivoting member 133 is maximally pivoted in the pivoting direction D1 as illustrated in FIGS. 2 to 4 and in a state in which the pivoting member 133 is located at the second position at which the pivoting member 133 is maximally pivoted in the pivoting direction D2 as illustrated in FIG. 5.

As described above, the support shaft 41 is provided with the first shaft gear 141 that rotates the support shaft 41. In addition, the first roller gear 153 is provided on the second shaft 510 that rotatably supports the driving roller 51a, and can rotate the driving roller 51a serving as the first driving roller. Here, the drive unit 120 can rotate the rotation shaft in both a clockwise direction and a counterclockwise direction in FIGS. 2 to 5. In other words, it is possible to generate a driving force for rotating the driving roller 51a in a first direction (corresponding to the pivoting direction D1 and counterclockwise direction in FIGS. 2 to 5) and a second direction (corresponding to the pivoting direction D2 and the clockwise direction in FIGS. 2 to 5) opposite to the first direction (pivoting direction D1). When the drive unit 120 rotates the driving roller 51a in the second direction (the pivoting direction D2), the power transmission mechanism 110 can transmit the driving force of the drive unit 120 as a rotational force in a direction (a reverse direction opposite to the conveyance direction A) of rewinding the medium to the first medium holding unit 42 side to the support shaft 41 serving as the first shaft.

Specifically, when the driving roller 51a rotates in the second direction (pivoting direction D2), the first roller gear 153 coupled to the second shaft 510 as the rotation shaft of the driving roller 51a also rotates in the second direction (pivoting direction D2). When the first roller gear 153 rotates in the second direction (pivoting direction D2), the gear 154 rotates in the first direction (pivoting direction D1). When the gear 154 rotates in the first direction (pivoting direction D1), the gear 155 rotates in the second direction (pivoting direction D2). When the gear 155 rotates in the second direction (pivoting direction D2), the sun gear 131 rotates in the first direction (pivoting direction D1), and the pivoting member 133 pivots in the pivoting direction D1, so that the planetary gear 132 meshes with the gear 146.

When the sun gear 131 rotates in the first direction (pivoting direction D1), the planetary gear 132 rotates in the second direction (pivoting direction D2). When the planetary gear 132 rotates in the second direction (pivoting direction D2), the gear 146 rotates in the first direction (pivoting direction D1). When the gear 146 rotates in the first direction (pivoting direction D1), the gear 145 rotates in the second direction (pivoting direction D2). When the gear 145 rotates in the second direction (pivoting direction D2), the gear 144 rotates in the first direction (pivoting direction D1). When the gear 144 rotates in the first direction (pivoting direction D1), the gear 143 rotates in the second direction (pivoting direction D2). When the gear 143 rotates in the second direction (pivoting direction D2), the gear 142 rotates in the first direction (pivoting direction D1). When the gear 142 rotates in the first direction (pivoting direction D1), the first shaft gear 141 rotates in the second direction (pivoting direction D2). When the first shaft gear 141 rotates in the second direction (pivoting direction D2), the roll paper RP also rotates in the second direction (pivoting direction D2) together with the support shaft 41, and the medium is wound.

In other words, the power transmission mechanism 110 according to the embodiment includes the sun gear 131 that is rotated by the driving force of the drive unit 120 and transmits the driving force of the drive unit 120 to the first roller gear 153, the planetary gear 132 that is rotatable around a rotation center of the sun gear 131 in a state of meshing with the sun gear 131, and the pivoting member 133 that is pivotable around the rotation center of the sun gear 131 in a state of holding the planetary gear 132. When the drive unit 120 rotates the driving roller 51a in the second direction (pivoting direction D2), the pivoting member 133 pivots such that the planetary gear 132 is located at the first position as illustrated in FIGS. 2 to 4, where the driving force of the drive unit 120 is transmitted to the first shaft gear 141. On the other hand, when the drive unit 120 rotates the driving roller 51a in the first direction (pivoting direction D1), the pivoting member 133 pivots such that the planetary gear 132 is located at the second position as illustrated in FIG. 5, where the driving force of the drive unit 120 is not transmitted to the first shaft gear 141.

When a leading end PA of the medium is located downstream of the first roller pair 51 in the conveyance direction A (forward direction), the control unit 80 controls the drive unit 120 to execute the following operations when the user performs an operation of removing the roll paper RP as the roll body from the first medium holding unit 42. First, a first reverse conveyance operation of rotating the driving roller 51a in the second direction (pivoting direction D2) such that the medium moves in the reverse direction opposite to the conveyance direction A by a first distance that is a desired distance is executed. Next, a first forward conveyance operation of rotating the driving roller 51a in the first direction (pivoting direction D1) such that the planetary gear 132 moves from the first position illustrated in FIGS. 2 to 4 to the second position illustrated in FIG. 5 is executed. Then, a second reverse conveyance operation of rotating the driving roller 51a in the second direction (pivoting direction D2) such that the medium moves in the reverse direction by a second distance that is a desired distance is executed.

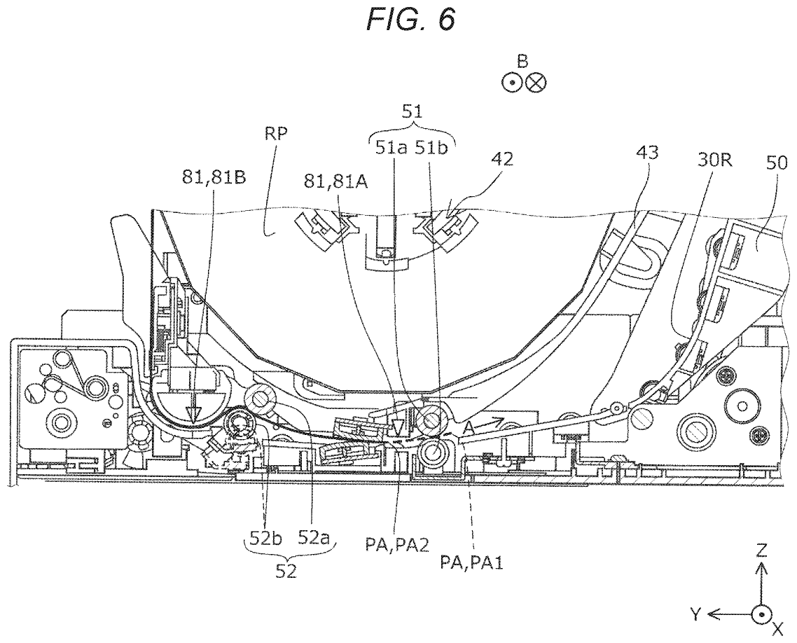

By executing such an operation, for example, as indicated by a broken line in FIG. 6, it is possible to prevent a situation in which the first roller pair 51 winds the leading end PA (leading end PA1) of the medium and the user cannot remove the roll body such as the roll paper RP. That is, by executing such an operation, when the roll body of the medium is taken out, for example, as illustrated by a solid line in FIG. 6, the leading end PA (leading end PA2) of the medium can be positioned upstream of the first roller pair 51 in the conveyance direction A (forward direction). Therefore, the printing device 1 according to the embodiment can easily take out the roll body of the medium.

Note that, in the printing device 1 according to the embodiment, the first forward conveyance operation corresponds to the movement operation of the planetary gear 132 from the first position to the second position (the release operation of the planetary gear 132), but in the second reverse conveyance operation, the operation amount is such that the planetary gear 132 does not reach the first position (the planetary gear 132 is maintained in the released state). In other words, the movement amount of the medium in the reverse direction generated by the second reverse conveyance operation is not larger than the movement amount of the medium in the forward direction generated by the first forward conveyance operation.

As illustrated in FIG. 6, the printing device 1 according to the embodiment includes a detection unit 81 capable of detecting the presence or absence of a medium. Specifically, the detection unit 81 includes a detection unit 81A and a detection unit 81B having the same configuration. Both the detection unit 81A and the detection unit 81B can detect that a position of the leading end PA of the medium is changed from the state of being at the detection position of the detection unit 81A and the detection unit 81B to the state of not being at the detection position of the detection unit 81A and the detection unit 81B and that the position of the leading end PA of the medium is changed from the state of not being at the detection position of the detection unit 81A and the detection unit 81B to the state of being at the detection position of the detection unit 81A and the detection unit 81B by detecting the presence or absence of the medium. With such a configuration, whether the medium is located at a predetermined position in the conveyance path 30 can be detected.

Both the detection unit 81A and the detection unit 81B are provided upstream of the first roller pair 51 in the conveyance path 30 in the conveyance direction A (forward direction). However, the present disclosure is not limited to such a configuration, and only one of the detection unit 81A and the detection unit 81B may be provided, or another detection unit 81 may be provided. Here, when the detection unit 81 detects, after the first reverse conveyance operation is completed, that the medium is located at the predetermined position, the control unit 80 executes the second reverse conveyance operation.

By executing such an operation, the second reverse conveyance operation can be performed only when the detection unit 81 detects the medium. That is, when it is not necessary to execute the second reverse conveyance operation, the second reverse conveyance operation can be omitted. For this reason, the printing device 1 according to the embodiment can perform the second reverse conveyance operation only when necessary, and therefore, it is possible to shorten the time required for taking out the roll body of the medium and to save power. In the printing device 1 according to the embodiment, the detection unit 81 detects the leading end PA of the medium by an optical method at a detection position upstream of the first roller pair 51 in the conveyance path 30 in the forward direction, thereby detecting whether the medium is located at the predetermined position in the conveyance path 30. However, the detection unit 81 may have a configuration different from that of the detection unit 81 according to the embodiment as long as the detection unit 81 can detect whether the medium is located at the predetermined position in the conveyance path 30.

In the printing device 1 according to the embodiment, the control unit 80 releases, after the second reverse conveyance operation is completed, the contact state in which the rollers of the second roller pair 52 come into contact with each other. Specifically, the driven roller 52b of the second roller pair 52 is moved from a position indicated by the solid line in FIG. 6 to a position indicated by the broken line in FIG. 6. By executing such an operation, when the leading end PA of the medium is inserted into the conveyance path 30 as the next roll body is attached, the leading end PA of the medium is not caught by the second roller pair 52 which is a roller pair upstream of the first roller pair 51 in the forward direction, and the operability when attaching the roll body can be improved.

In the printing device 1 according to the embodiment, the detection unit 81 executes, after the first forward conveyance operation is completed, the operation of detecting whether the medium is located at the predetermined position under the control of the control unit 80. By executing such an operation, the second reverse conveyance operation can be performed only when necessary. That is, when it is not necessary to execute the second reverse conveyance operation, the second reverse conveyance operation can be omitted. Therefore, it is possible to shorten the time required for taking out the roll body of the medium and to save power.

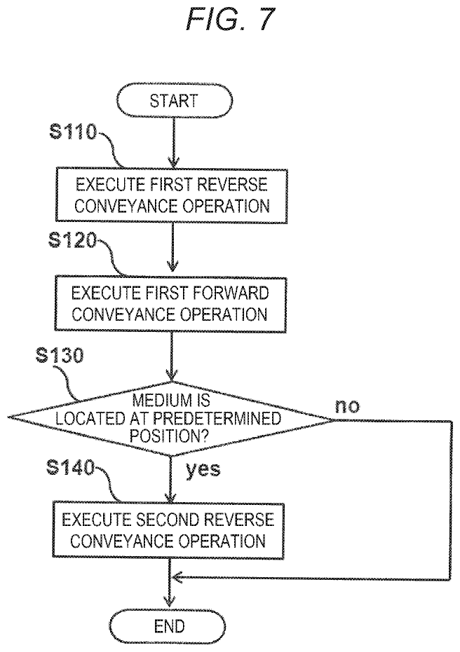

Here, a flow of removing the roll body in the printing device 1 according to the embodiment will be described with reference to FIG. 7. When the roll body is to be removed, first, the first reverse conveyance operation is executed in step S110. Next, the first forward conveyance operation is executed in step S120. Next, in step S130, the detection unit 81 executes a detection operation to detect whether the medium is located at the predetermined position. When it is detected in step S130 that the medium is located at the predetermined position, that is, when the leading end PA of the medium is not detected yet, it is determined that the medium may be nipped by the first roller pair 51, and the process proceeds to step S140 to execute the second reverse conveyance operation. When the second reverse conveyance operation is executed in step S140, this flow ends. On the other hand, when it is not detected in step S130 that the medium is located at the predetermined position, that is, when the leading end PA of the medium is detected, it is determined that there is no possibility that the medium is nipped by the first roller pair 51, and the flow ends without proceeding to step S140, that is, without executing the second reverse conveyance operation.

The present disclosure is not limited to the examples described above and can be implemented in various configurations without departing from the gist of the present disclosure. In order to solve some or all of the problems described above or to achieve some or all of the effects described above, the technical features in the embodiment corresponding to the technical features in the respective aspects described in the summary can be substituted or combined as appropriate. Further, any of the technical features can be eliminated as appropriate unless described as essential in the present specification.

What is claimed is:

1. A printing device comprising:
a medium holding unit including a first shaft that rotatable holds a roll body obtained by winding a long medium in a roll shape;
a conveyance path through which the medium is to be conveyed;
a printing unit facing the conveyed medium;
a first roller pair including a first driving roller and a first driven roller, and rotating to convey the medium in a forward direction and a reverse direction opposite to the forward direction;
a first shaft gear provided on the first shaft and configured to rotate the first shaft;
a first roller gear provided on a second shaft that rotatably supports the first driving roller, and configured to rotate the first driving roller;
a drive unit configured to generate a driving force for rotating the first driving roller in a first direction and a second direction opposite to the first direction;
a power transmission mechanism configured to transmit, when the drive unit rotates the first driving roller in the second direction, the driving force of the drive unit to the first shaft as a rotational force in a direction in which the medium is rewound to the medium holding unit side; and
a control unit configured to control the drive unit, wherein
the power transmission mechanism includes a sun gear rotated by the driving force of the drive unit and transmitting the driving force of the drive unit to the first roller gear, a planetary gear rotatable about a rotation center of the sun gear in a state in which the planetary gear meshes with the sun gear, and a pivoting member pivotable about the rotation center of the sun gear in a state in which the planetary gear is held,
when the drive unit rotates the first driving roller in the second direction, the pivoting member pivots such that the planetary gear is located at a first position at which the driving force of the drive unit is transmitted to the first shaft gear, and when the drive unit rotates the first driving roller in the first direction, the pivoting member pivots such that the planetary gear is located at a second position at which the driving force of the drive unit is not transmitted to the first shaft gear, and
when a user performs an operation of removing the roll body from the medium holding unit in a state in which a leading end of the medium is located downstream of the first roller pair in the forward direction, the control unit controls the drive unit to
execute a first reverse conveyance operation of rotating the first driving roller in the second direction such that the medium moves in the reverse direction by a first distance,
execute a first forward conveyance operation of rotating the first driving roller in the first direction such that the planetary gear moves from the first position to the second position, and
execute a second reverse conveyance operation of rotating the first driving roller in the second direction such that the medium moves in the reverse direction by a second distance.

2. The printing device according to claim 1, further comprising:
a detection unit provided upstream of the first roller pair in the conveyance path in the forward direction and configured to detect whether the medium is located at a predetermined position in the conveyance path, wherein
the control unit executes the second reverse conveyance operation when the detection unit detects that the medium is located at the predetermined position after the first reverse conveyance operation is completed.

3. The printing device according to claim 1, further comprising:
a second roller pair including a second driving roller and a second driven roller, and configured to rotate so as to convey the medium in the forward direction and the reverse direction, wherein
the second roller pair is located upstream of the first roller pair in the forward direction, and is configured to nip, when a curl occurs in the medium, a curl portion, which is a portion where the curl occurs, to bend the medium in a direction of correcting the curl portion.

4. The printing device according to claim 3, wherein
the control unit releases, after the second reverse conveyance operation is completed, a contact state in which the rollers of the second roller pair come into contact with each other.

5. The printing device according to claim 2, wherein
the detection unit executes, after the first forward conveyance operation is completed, an operation of detecting whether the medium is located at the predetermined position.
